(19) United States
(12) Patent Application Publication
(10) Pub. No.: US 2007/0263349 A1
(43) Pub. Date: Nov. 15, 2007

(54) Fixing Support of Data Accessing Device

(76) Inventors: Chieh-Shih YI, Xindian City (TW); Chun-An Wu, Xindian City (TW)

Correspondence Address: HDSL, 4331 STEVENS BATTLE LANE, FAIRFAX, VA, 22033, US

(21) Appl. No.: 11/383,151

(22) Filed: May 12, 2006

(51) Int. Cl. G06F 1/16

(52) U.S. Cl. 361/685

(57) ABSTRACT

A fixing support of a data accessing device includes a frame body and a plurality of base posts. The top face of the frame body is used for supporting the data accessing device. Further, a plurality of leg bases is provided for supporting upwardly the top face of the frame body. A plurality of major holes is provided on the leg base. The edge of each major hole is formed with a minor hole facing toward the same side. Each base post faces each major hole and is fixedly provided on the casing, base body, top wall or side wall of the electronic product. Each base post is provided with a cap head thereon. An annular groove is formed between each cap head and the associated base post. With the above arrangement, each cap head can penetrate the associated major hole to fasten each minor hole into the annular groove, thereby to achieve the rapid assembling.

### BACKGROUND OF THE INVENTION

1. Field of the Invention

The present invention relates to an improved structure of a fixing support of a data accessing device capable of fitting a data accessing device such as a hard disk driver or optical disk driver into an electronic product and capable of being rapidly and conveniently assembled and disassembled.

2. Description of Prior Art

With the rapid development of electronic technology industries, the data accessing device (such as hard disk driver and optical disk driver) applied to the computer in the past recently turns to be widely used in other related electronic products such as multi-medium audio/video player. Since such kind of multi-medium audio/video player provides audio/video information by means of a highly efficient data storage medium, the data accessing device (such as the hard disk driver or optical disk driver) arranged within the multi-medium audio/video player is thus very important. Nowadays, the above device and the fixing support thereof are mostly fastened by means of bolts. Even in some cases, the fixing support is directly welded on the frame of the casing of such device and thus cannot be disassembled. As a result, the repair and renewal of the product in the future will be more inconvenient. The biggest problem encountered by most manufacturers is the consumption of time in assembling, which does not conform to the requirements for saving the cost of molds.

In view of the above, the inventor proposes the present invention to overcome the above problems based on his expert experiences and deliberate researches.

### SUMMARY OF THE INVENTION

The present invention is to provide an improved structure of a fixing support of a data accessing device capable of rapidly and conveniently fitting a data accessing device such as a hard disk driver or optical disk driver into an electronic product and capable of being rapidly assembled and disassembled. Further, the present invention can save the time in design and the cost of molds with a lesser amount of screws.

The present invention is further to provide an improved structure of an improved structure of a fixing support of a data accessing device, in which an elastic vibration-attenuating mechanism is provided between the fixing support and the data accessing device and between the fixing support and the casing, base body, top wall or side wall of the electronic product. Therefore, in addition to achieve the above objects, a double-layered vibration-attenuating effect can be also achieved.

Accordingly, the present invention provides an improved structure of a fixing support of a data accessing device, which comprises a frame body and a plurality of base posts. The top face of the frame body is used for supporting the data accessing device. Further, a plurality of leg bases is provided for supporting upwardly the top face of the frame body. A plurality of major holes is provided on the leg base. The edge of each major hole is formed with a minor hole facing toward the same side. Each base post faces each major hole and is fixedly provided on the casing, base body, top wall or side wall of the electronic products. Each base post is provided with a cap head thereon. An annular groove is formed between each cap head and the associated base post. With the above arrangement, each cap head can penetrate the associated major hole to fasten each minor hole into the annular groove.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an exploded perspective view showing that the present invention is disposed on the base;

FIG. 2 is an assembled perspective view showing that the present invention is disposed on the base;

FIG. 3 is a perspective view showing the external appearance of the frame body of the present invention;

FIG. 4 is an assembled view of the frame body and the data accessing device of the present invention;

FIG. 5 is a schematic view showing the action before the assembling of the present invention;

FIG. 6 is a schematic view showing the action after the assembling of the present invention;

FIG. 7 is a side cross-sectional view showing that the present invention is disposed on the base; and

FIG. 8 is a side cross-sectional view showing that the fixing support of another embodiment of the present invention is disposed on the base.

### DETAILED DESCRIPTION OF THE INVENTION

In order to make the Examiner better understand the characteristics and the technical contents of the present invention, a detailed description relating to the present invention will be made with reference to the accompanying drawings. However, it should be understood that the drawings are illustrative but not used to limit the scope of the present invention.

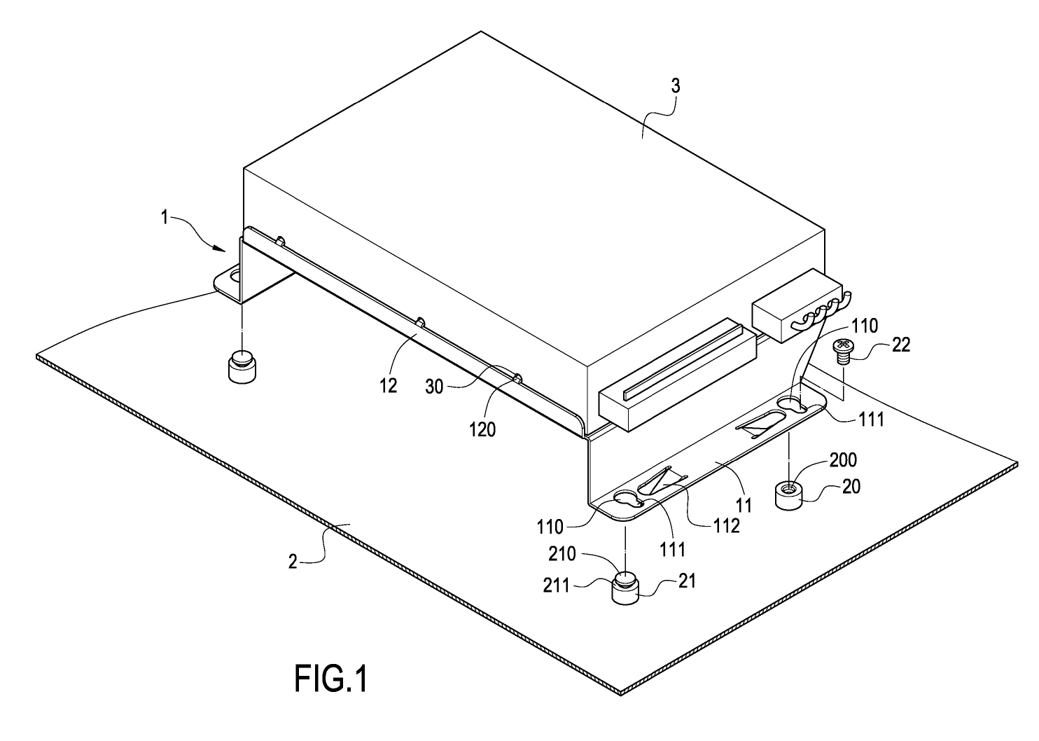

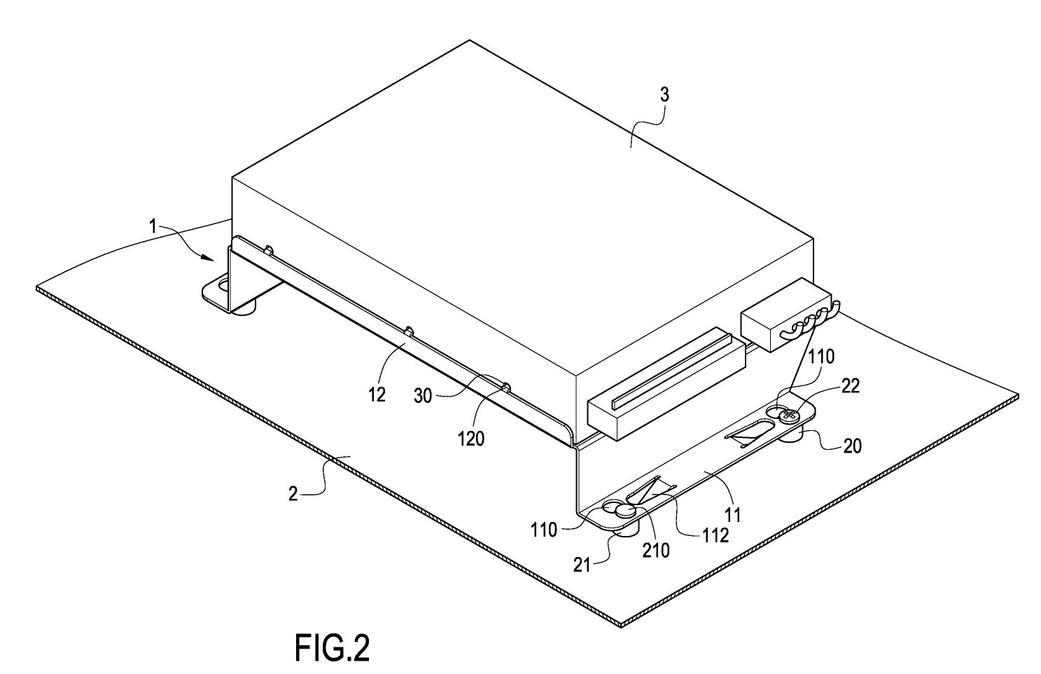

With reference to FIG. 1 and FIG. 2, which are an exploded perspective view and an assembled perspective view showing that the present invention is disposed on the base. The present invention provides an improved structure of a fixing support of a data accessing device. The fixing support 1 is used for supporting a data accessing device 3 thereon and fixing the data accessing device 3 on a base 2. The data accessing device 3 can be a hard disk driver, optical disk driver or the like. The base 2 can be a casing, seat body, top wall or side wall of a common electronic product for fixing the position of the data accessing device 3. The fixing support 1 comprises a frame body 10, a first base post 20 and a plurality of second base posts 21.

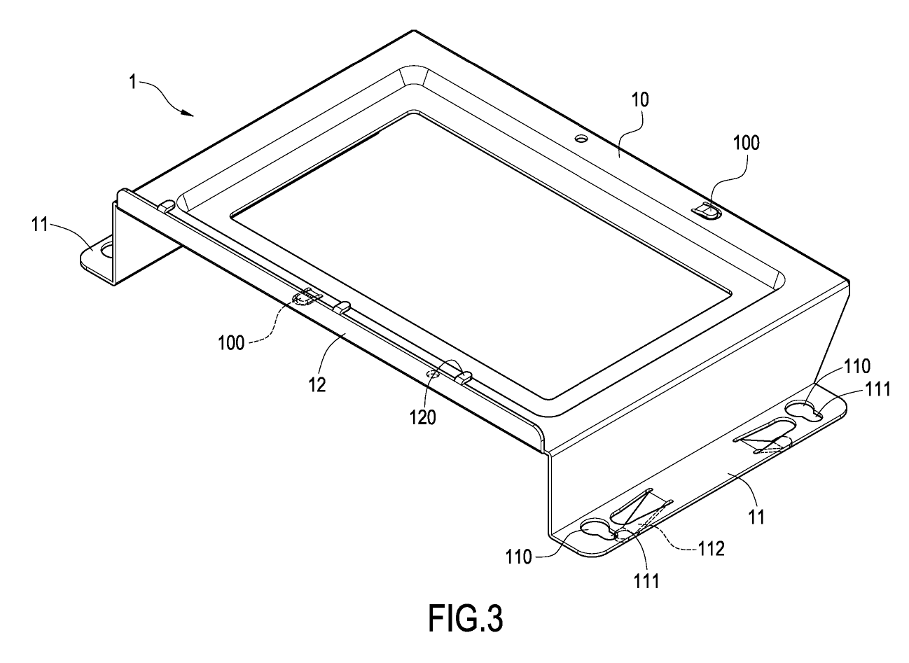

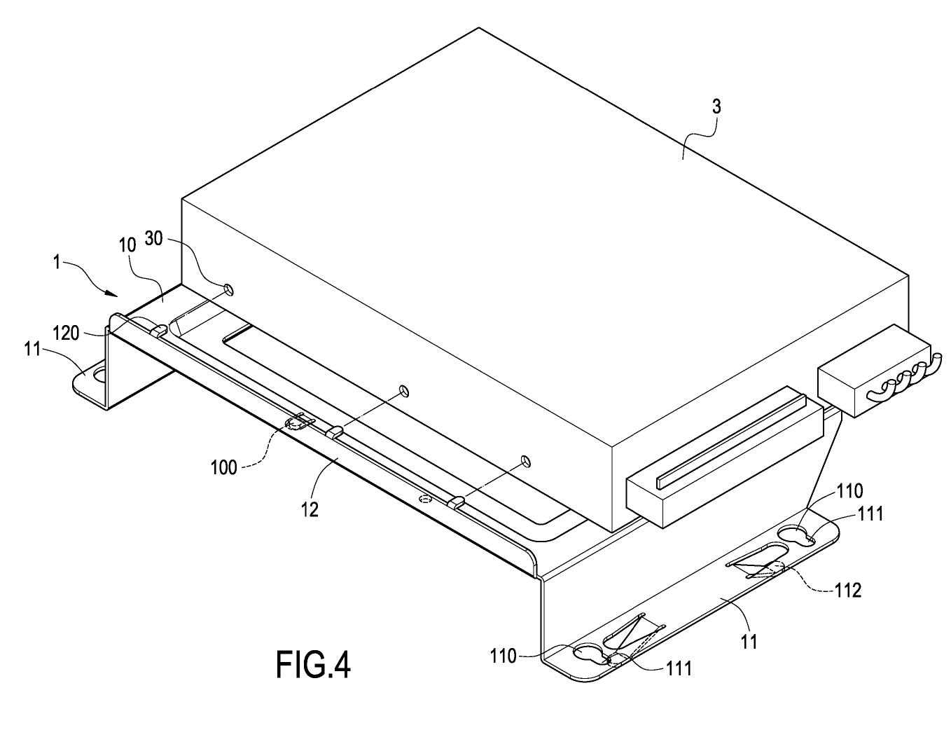

The frame body 10 can be made by means of pressing and bending a metallic plate. With reference to FIG. 3 and FIG. 4, the formed frame body 10 has at least one pair of leg bases 11 bending downwardly from the side thereof. The cross section of the leg base 11 can be formed into a “L” shape so as to support upwardly the top face of the frame body 10 to a proper height. The data accessing device is stably disposed on the top face of the frame body 10 (as shown in FIG. 4). On the top face of the frame body 10, first elastic pressing pieces 100 are provided for butting upwardly. When the data accessing device 3 is horizontally disposed on the top face of the frame body 10, the elastic pressing pieces 100 abut against the bottom surface of the data accessing device 3 and thus provide a proper elastic force for attenuating the vibration. Further, one side of the frame body 10 is bent upwardly to form with a stopping wall 12 for abutting against the side of the data accessing device 3 having locking holes 30. A plurality of inserting portions 120 projects form the stopping wall 12 to correspond to the locking holes 30. Each inserting portion 120 is formed into a short pin for just inserting into each locking holes 30 of the data accessing device 3 so as to fix the data accessing device 3 on the frame body 10.

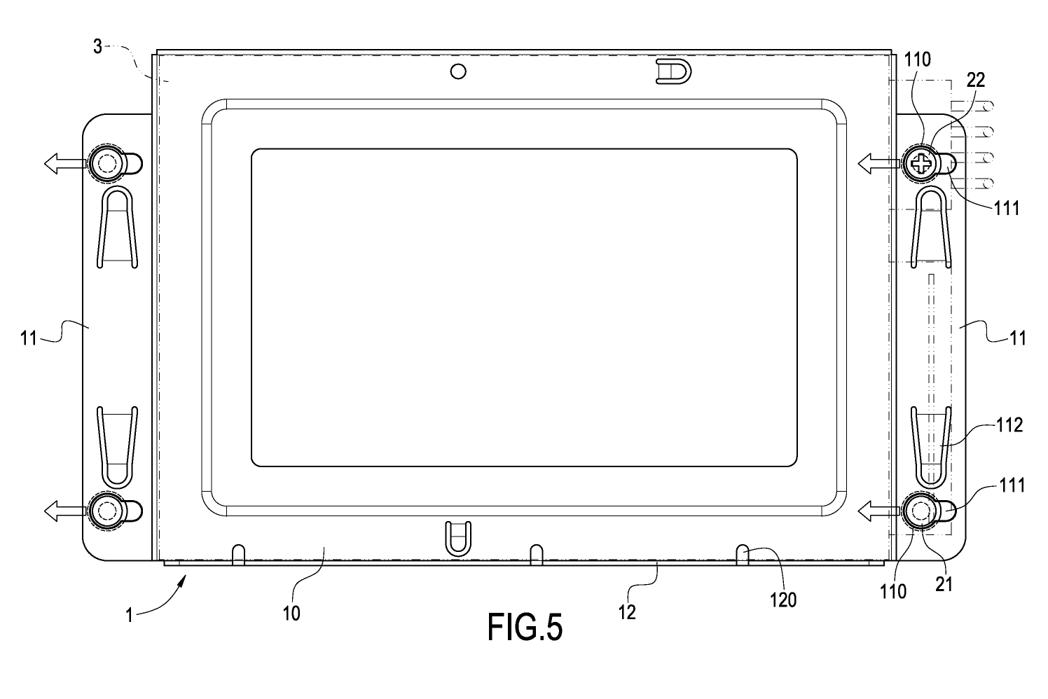

According to the above, the upright section of the “L-shaped” leg base 11 extends from the side of the top face of the frame body 10, and the bottom section of the “L-shaped” leg base 11 is provided with a plurality of major holes 110. The edge of each major hole 110 is formed with a minor hole 111 facing toward the same side (as shown in FIG. 5). Further, each minor hole 111 is communicated with the associated major hole 110. In addition, on the leg base 11, second elastic pressing pieces 112 are provided to abut downwardly. When the fixing support 1 is horizontally disposed on the base 2, the elastic pressing pieces 112 abut against the surface of the base 2 so as to provide a proper elastic force for attenuating the vibration.

With reference to FIG. 1 and FIG. 2 again, the first base posts 20 and second base posts 21 are fixedly provided on the base 2, respectively. Each base post 20 or 21 faces each major hole 110 of the leg base 11. The first base post 20 is provided with a positioning hole 200. The positioning hole 200 can be a screw hole so that a fixing piece 22 such as screw can be screwed on the first base post 20. On the other hand, the top end of each of the remaining second base posts 21 is provided with a cap head 210. An annular groove 211 is formed between the cap head 210 and the associated second base post 21.

With the above constitution, the improved structure of a fixing support of a data accessing device can be accomplished.

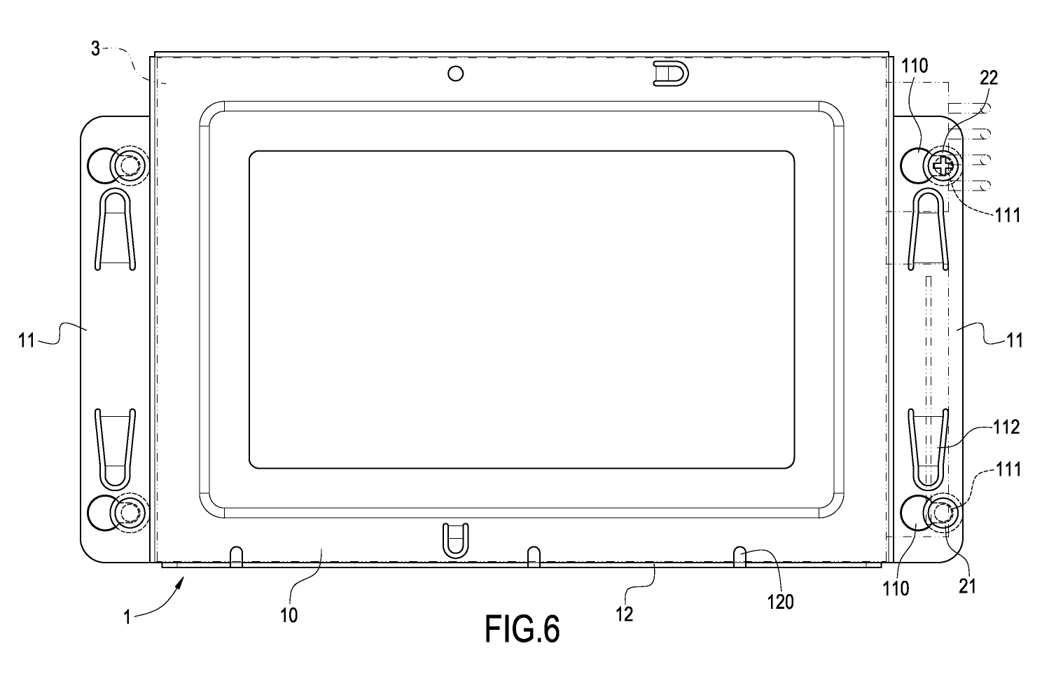

With reference to FIG. 1 and FIG. 5, when the fixing support 1 is to be assembled on the base 2, the cap head 210 of the second base post 21 penetrates the associated major hole 110 so that each minor hole 111 can be aligned with the associated annular groove 211. Thereafter, the frame body 10 is further pushed toward one side so that each minor hole 111 is locked into the annular groove 211 and fixed thereto, as shown in FIG. 6. Therefore, the rapid assembling or disassembling can be accomplished. Further, the structure of the present invention can save the time in design and the cost of molds.

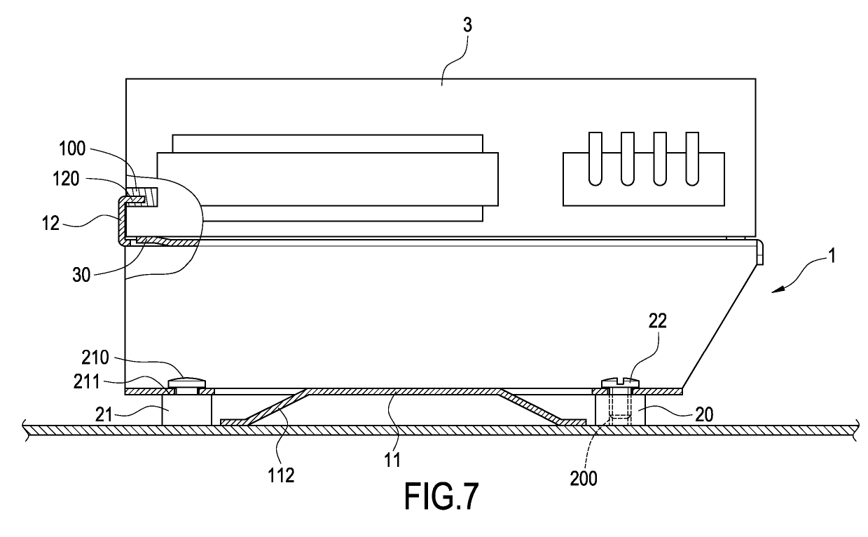

Moreover, as shown in FIG. 7, in order to provide a better stability in assembling, at least one first base post 20 can be used to serve as the base post 20 or 21. Namely, if it is unnecessary to use the fixing piece 22 such as screw to provide a stable connection, all the base posts can be the second base posts 21. However, if a more stable assembling is required, at least one of the base posts should adopt the first base post 20 and the associated fixing piece 22. Therefore, by screwing the fixing piece 22 into the positioning hole 200 of the first base post 20, the stable assembling can be achieved. Since only one fixing piece 22 is used and the fixing piece is usually a screw, the amount of the screws can be greatly reduced.

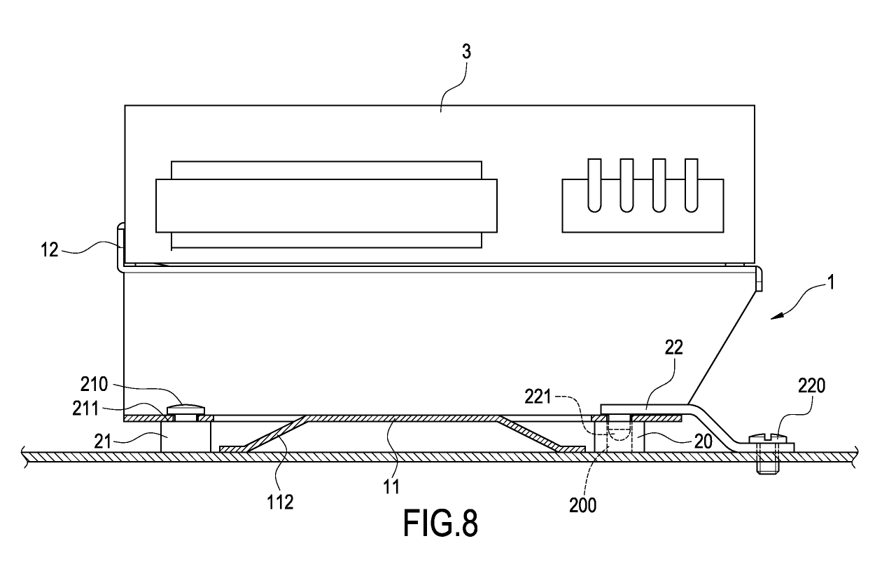

Further, as shown in FIG. 8, it is a side cross-sectional view showing that the fixing piece of another embodiment of the present invention is disposed on the base. The fixing piece 22 can be made of an elastic piece. One end of the fixing piece is screwed on the base 2 by another screw 220, and the other end thereof is provided with a projecting post 221 for projecting downwardly to correspond to the positioning hole 200 of the first base post 20 and penetrate therein. In this way, the stable assembling can be achieved. Of course, the fixing piece 22 and the positioning hole 200 can be detachably provided to achieve the same effect.

According to the above, the present invent indeed achieves the desired effects and overcomes the drawbacks of prior art by employing the above structures. Therefore, the present invention involves the novelty and inventive steps, and conforms to the requirements for a utility model patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A fixing support of a data accessing device for supporting the data accessing device to fix on a base, comprising:
a frame body for supporting the data accessing device with a top face thereof and having a plurality of leg bases for supporting upwardly the top face of the frame body, the leg bases provided with a plurality of major holes, the edge of each major hole formed with a minor hole facing toward the same side, each minor hole communicated with associated major hole;
a first base post facing one major hole of the leg bases and fixedly provided on the base, the first base post provided with a positioning hole; and
a plurality of second base posts facing remaining major holes of the leg bases and fixedly provided on the base, each second base post provided with a cap head, an annular groove formed between each cap head and associated second base post,
wherein each cap head penetrates the associated major hole to fasten each minor hole into the annular groove so as to detachably provide with a fixing piece on the positioning hole, and the fixing piece penetrates the minor hole corresponding to the first base post to connect with the positioning hole.

2. The fixing support of a data accessing device according to claim 1, wherein the top face of the frame body is provided with first elastic pressing pieces for abutting upwardly.

3. The a fixing support of a data accessing device according to claim 2, wherein the leg base is provided with second elastic pressing pieces for abutting downwardly.

4. The fixing support of a data accessing device according to claim 1, wherein one side of the frame body is bent upwardly to form with a stopping wall, a plurality of inserting portions project from the stopping wall, and each inserting portion is used for inserting into a locking hole of the data accessing device.

5. The fixing support of a data accessing device according to claim 1, wherein the leg base is formed into a “L” shape, an upright section of the “L” shape extends from a side of the top face of the frame body, and a bottom section of the “L” shape is provided with the major hole.

6. The fixing support of a data accessing device according to claim 1, wherein the positioning hole of the first base post is a screw hole and the fixing piece is a screw.

7. The fixing support of a data accessing device according to claim 1, wherein the fixing piece is an elastic piece, one end of the fixing piece is fixedly provided on the base, and the other end thereof is provided with a projecting post for projecting downwardly to correspond to the positioning hole and penetrate therein.

8. A fixing support of a data accessing device for supporting the data accessing device to fix on a base, comprising:
a frame body for supporting the data accessing device with a top face thereof and having a plurality of leg bases for supporting upwardly the top face of the frame body, the leg bases provided with a plurality of major holes, an edge of each major hole formed with a minor hole facing toward the same side, each minor hole communicated with associated major hole; and
a plurality of base posts facing the major holes respectively and fixedly provided on the base, each base post provided with a cap head, an annular groove formed between each cap head and associated base post,
wherein each cap head penetrates associated major hole to fasten each minor hole into the annular groove.

9. The fixing support of a data accessing device according to claim 8, wherein the top face of the frame body is provided with first elastic pressing pieces for abutting upwardly.

10. The fixing support of a data accessing device according to claim 9, wherein the leg base is provided with second elastic pressing pieces for abutting downwardly.

11. The fixing support of a data accessing device according to claim 8, wherein one side of the frame body is bent upwardly to form with a stopping wall, a plurality of inserting portions project from the stopping wall, and each inserting portion is used for inserting into a locking hole of the data accessing device.

12. The fixing support of a data accessing device according to claim 8, wherein the leg base is formed into a “L” shape, an upright section of the “L” shape extends from a side of the top face of the frame body, and a bottom section of the “L” shape is provided with the major hole.
